(19) United States
(12) Patent Application Publication
(10) Pub. No.: US 2012/0008310 A1
(43) Pub. Date: Jan. 12, 2012

(54) Handheld lighting unit

(76) Inventors: Tom STAEUBLI, Zurich (CH); Uwe WERNER, Hutten (CH); Arno LENZI, Zurich (CH); Georgios MARGARITIS, Schwieberdingen (DE)

(21) Appl. No.: 13/135,354

(22) Filed: Jun. 30, 2011

(30) Foreign Application Priority Data
Jul. 9, 2010 (DE) 10 2010 031 163.4

(51) Int. Cl. B25B 23/18; F21V 33/00

(52) U.S. Cl. 362/119; 362/109

(57) ABSTRACT

A handheld lighting unit includes a light-emitting device having (i) at least one first surface lighting arrangement which emits a light flux in a first lighting direction, and (ii) a second surface lighting arrangement which emits a light flux in a second lighting direction different from the first lighting direction.

### BACKGROUND OF THE INVENTION

1. Field of the Invention

The present invention relates to a handheld lighting unit.

2. Description of the Related Art

A handheld lighting unit has already been proposed which includes a light-emitting device having at least one first surface lighting means which emits a light flux in a first lighting direction.

### BRIEF SUMMARY OF THE INVENTION

The present invention provides a handheld lighting unit which includes a light-emitting device having at least one first surface lighting means which emits a light flux in a first lighting direction.

It is proposed that the light-emitting device has a second surface lighting means which emits a light flux in a second lighting direction which is different from the first lighting direction. A “light-emitting device” is understood to be, in particular, a device which during operation converts an electrical power into a light flux for illuminating, in particular a workstation. The light flux preferably has a power of at least 50 lumens, advantageously at least 150 lumens. The light-emitting device advantageously emits a light flux of white light. In particular, a “surface lighting means” is understood to be a means having a light output surface which is designed to be greater than 25 cm², advantageously greater than 50 cm², particularly advantageously greater than 100 cm². The surface lighting means preferably transilluminates the light output surface in a largely uniform manner, i.e., in particular having a deviation from an average transillumination intensity of less than 25%. As an alternative or in addition, the surface lighting means could have at least three spotlight-emitting illuminants, at least one light guide element and/or advantageously one, in particular movable, diffuser. The surface lighting means advantageously has multiple individual illuminants whose light fluxes at least partially overlap. A “light output surface” is understood to be, in particular, a surface which is spanned by light output areas of the illuminants. The light flux advantageously exits the light-emitting device and, in particular, the handheld lighting unit, via the light output surface. The term “lighting direction” is understood to be, in particular, an average orientation of a light flux of the surface lighting means. The light flux preferably has a radiation angle of less than 210 degrees, advantageously less than 180 degrees. The light flux advantageously has a radiation angle greater than 30 degrees, advantageously greater than 90 degrees, particularly advantageously greater than 120 degrees. The surface lighting means advantageously radiates more than 90% of a light power of the light flux within the radiation angle. In particular, a “second lighting direction which is different from the first lighting direction” is understood to be a lighting direction in which the outgoing light fluxes, in particular the light fluxes which are not reflected by third surfaces, overlap by less than 50%, advantageously less than 10%. Due to the embodiment according to the present invention, a particularly versatile and advantageously low-glare handheld lighting unit may be achieved.

In a further embodiment, it is proposed that the handheld lighting unit has a coupling means which is provided to establish an operative connection to a handheld power tool battery, which enables handheld power tool batteries and a charging infrastructure of the handheld power tool batteries to be used in a particularly versatile and efficient manner. A “coupling means” is understood to be, in particular, an interface which is designed to be connectable to a handheld power tool battery. The connection of the coupling means is preferably separable without tools. The expression “separable without tools” is understood to mean, in particular, that the coupling means is separably fastened to the handheld power tool battery by the operator entirely by hand. “Provided” is understood to mean, in particular, specially programmed, designed and/or equipped. In particular, an “operative connection” is understood to be a conductive connection for electrical power transmission and/or, in particular, a mechanically secure connection for fastening purposes. A “handheld power tool battery” is understood to be, in particular, a battery which is provided for the purpose of supplying a handheld power tool with electrical power. In particular, the handheld power tool battery is specifically protected against dust and dirt and/or adapted to a power rating of the handheld power tool. The handheld power tool battery preferably includes multiple cells and/or a voltage of more than 3.6 volts, advantageously more than 9 volts. In particular, the handheld power tool battery advantageously includes lithium cells. In particular, the handheld power tool battery is provided for the purpose of delivering a power output of more than 25 watts, advantageously more than 50 watts and particularly advantageously more than 100 watts. In particular, the handheld power tool battery is provided for the purpose of supplying a drive motor of a handheld power tool with electrical power.

It is furthermore proposed that the light-emitting device has a switching unit which controls the surface lighting means by switching them separately, which makes it possible to use the light-emitting device in a particularly comfortable and flexible manner which, in particular, is gentle on the battery. In particular, a deactivated surface lighting means may be used as a glare protection for the operator. A “switching unit” is understood to be, in particular, a unit which is provided to vary a power of the light flux from the surface lighting means at least as a function of an operator input. The switching unit is preferably provided to activate and deactivate a power supply of the surface lighting means. In particular, the switching unit is provided to initiate a change in the power consumption of the surface lighting means, i.e., to dim the surface lighting means. In particular, the expression “control by switching separately” is understood to mean that the switching unit is provided to supply the surface lighting means with power intensities which are separately influenceable by the operator.

It is furthermore proposed that the surface lighting means are situated at an angle of at least 90 degrees between the first lighting direction and the second lighting direction, which makes it possible to illuminate a particularly large area with low glare and few shadows. The expression “at an angle between the first lighting direction and the second lighting direction” is understood to mean, in particular, that the two lighting directions encompass an angle of at least 90 degrees on at least one plane on which both lighting directions preferably lie. The angle is advantageously approximately 180 degrees.

It is furthermore proposed that at least one of the surface lighting means is designed to be deformable, which makes it possible to advantageously vary an illumination pattern using structurally simple means. The term “deformable” is understood to mean, in particular, that the surface lighting means is designed to be able to move at least 5 degrees, advantageously at least 15 degrees, particularly advantageously at least 30 degrees between two partial surfaces, in particular due to a force applied by the operator. The surface lighting means is advantageously deformable into a concave and/or advantageously convex shape on an outer side. Alternatively or in addition, a surface lighting means could be pivotably mounted, in particular, around the main extension direction.

In an advantageous embodiment of the present invention, it is proposed that at least one of the surface lighting means has multiple individual illuminants distributed over a wide area, which makes it possible to achieve a particularly uniform light radiation using structurally simple means. “Distributed over a wide area” is understood to mean that the individual illuminants span a surface on a plane of at least 25 cm², advantageously 50 cm². The individual illuminants are preferably situated at a distance of at least 0.5 cm, advantageously at least 1 cm, from each other. As an alternative or in addition, the surface lighting means could have at least one light guide element.

It is furthermore proposed that at least one of the surface lighting means has at least one individual illuminant which is designed as a light-emitting diode, which makes it possible to generate light particularly reliably, energy-efficiently and over a long life cycle. The surface lighting means advantageously has multiple light-emitting diodes. As an alternative or in addition, at least one of the surface lighting means could have an incandescent lamp, a gas discharge lamp, an induction lamp and/or an electroluminescent film.

It is furthermore proposed that the handheld lighting unit has a non-round outer contour on at least one plane which is oriented perpendicularly to a main extension, which makes it possible to advantageously set down and abut the handheld lighting unit and, in particular, to prevent the handheld lighting unit from rolling. In particular, “non-round outer contour” is understood to mean a contour which deviates, in particular substantially, from a circular shape, i.e., by more than 20%. The term “main extension” is understood to mean, in particular, a direction along a straight line which extends through two points of the handheld lighting unit located the farthest distance apart. The handheld lighting unit preferably has a non-round outer contour along 25% of the main extension, advantageously along 50% of the main extension. The handheld lighting unit preferably has an asymmetrical outer contour on at least one transverse plane which is oriented perpendicularly to a main extension, advantageously on a plane which is situated at a distance from the operating element. A surface center point of the light-emitting device is advantageously situated on the transverse plane at a distance from a vertical of the transverse plane through a surface center point of the handle area on the transverse plane.

It is furthermore proposed that the handheld lighting unit has fastening means which are situated at least partially in two end areas, which makes it possible to carry and/or attach the handheld lighting unit in a particularly comfortable and flexible manner. A “fastening means” is understood, in particular, to be a means which is provided for the purpose of absorbing a fastening force. In particular, the term “end area” is understood to be an area which is situated at one of the two ends of the handheld lighting unit along the main extension of the handheld lighting unit.

### BRIEF DESCRIPTION OF THE DRAWINGS

FIG. 1 shows a perspective view of a system according to the present invention having a handheld lighting unit according to the present invention and a handheld power tool battery.

FIG. 2 shows the system from FIG. 1, having a removed handheld power tool battery in a side view.

FIG. 3 shows a top view of the system from FIG. 1.

FIG. 4 shows the system from FIG. 1, which is attached to an operator.

FIG. 5 shows a further exemplary embodiment of the system according to the present invention, having a pivoting device.

### DETAILED DESCRIPTION OF THE INVENTION

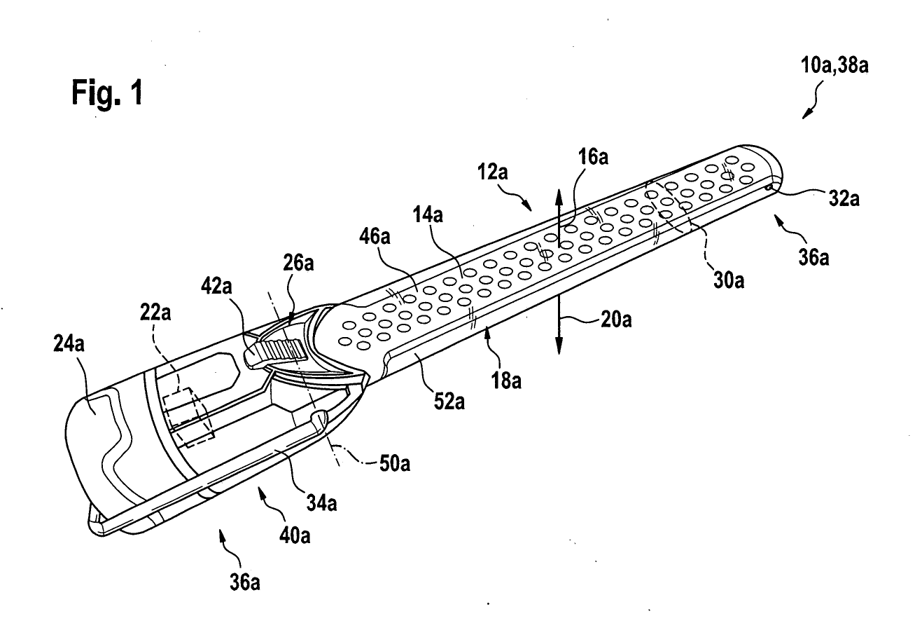

FIGS. 1 through 3 show a system 38a which includes a handheld lighting unit 10a and a handheld power tool battery 24a. Handheld lighting unit 10a includes a light-emitting device 12a, a coupling means 22a, fastening means 32a, 34a and a handle area 40a. Light-emitting device 12a has a ratio of length in a main extension to width of more than 4 to 1. Light-emitting device 12a also has a ratio of length in a main extension to depth of more than 6 to 1. Handle area 40a is situated in an extension of light-emitting device 12a. Handheld lighting unit 10a thus has a sword-shaped outer contour.

Coupling means 22a has electrically conductive contacts and mechanical locking and fastening elements, which are not illustrated in further detail. In the operational state, these elements establish an electrically conductive and mechanically stable connection to handheld power tool battery 24a.

Light-emitting device 12a has a first surface lighting means 14a and a second surface lighting means 18a. First surface lighting means 14a emits a light flux in a first lighting direction 16a. Second surface lighting means 18a emits a light flux in a second lighting direction 20a. Second lighting direction 20a has a different orientation than first lighting direction 16a. Surface lighting means 14a, 18a are situated at an angle of approximately 180 degrees between first lighting direction 16a and second lighting direction 20a.

The light-emitting device includes a switching unit 26a. During operation, switching unit 26a controls the two surface lighting means 14a 18a separately from each other in a manner which is dependent on an operator. For this purpose, switching unit 26a has an electronic system, which is not illustrated in further detail, and an operating element 42a. With the aid of operating element 42a, an operator 44a may activate and deactivate first surface lighting means 14a and second surface lighting means 18a independently of each other. For example, moving operating element 42a up could dim or switch first surface lighting means 14a on and off. Moving operating element 42a down could dim or switch second surface lighting means 18a on and off. The electronic system provides a corresponding voltage and/or a corresponding current.

The switching unit has a sensor, which is not illustrated in further detail and which detects a parameter of handheld power tool battery 24a. The parameter is provided as a voltage of handheld power tool battery 24a. Upon dropping below a charge level of handheld power tool battery 24a determined from the voltage, the switching unit sends a signal to the operator via light-emitting device 12a. For example, the switching unit deactivates light-emitting device 12a for a very short period of time. Alternatively, the switching unit could have an interface, for example for monitoring a temperature of the handheld power tool battery. An excess of a temperature of the battery could also be indicated to the operator with the aid of another, for example, settable signal, even a color signal.

The two surface lighting means 14a, 18a are designed to be deformable. For this purpose illuminants 28a of surface lighting means 14a, 18a are each fastened and electrically contacted on a flexible printed circuit board 46a of surface lighting means 14a, 18a. Flexible printed circuit boards 46a are designed in such a way that they may be bent by operator 44a. Thus, operator 44a may move a center of flexible printed circuit boards 46a in each lighting direction 16a, 18a with the aid of an adjusting mechanism of handheld lighting unit 10a, which is not illustrated in further detail. An outer side of flexible printed circuit board 46a situated in lighting direction 16a, 20a is thereby convexly deformable. The adjusting mechanism could cause, for example, an elevated gas pressure between the two surface lighting means 14a. Alternatively, handheld lighting unit 10a could also have another adjusting mechanism which appears practical to those skilled in the art. It would also be possible for only one of the surface lighting means to have a flexible printed circuit board.

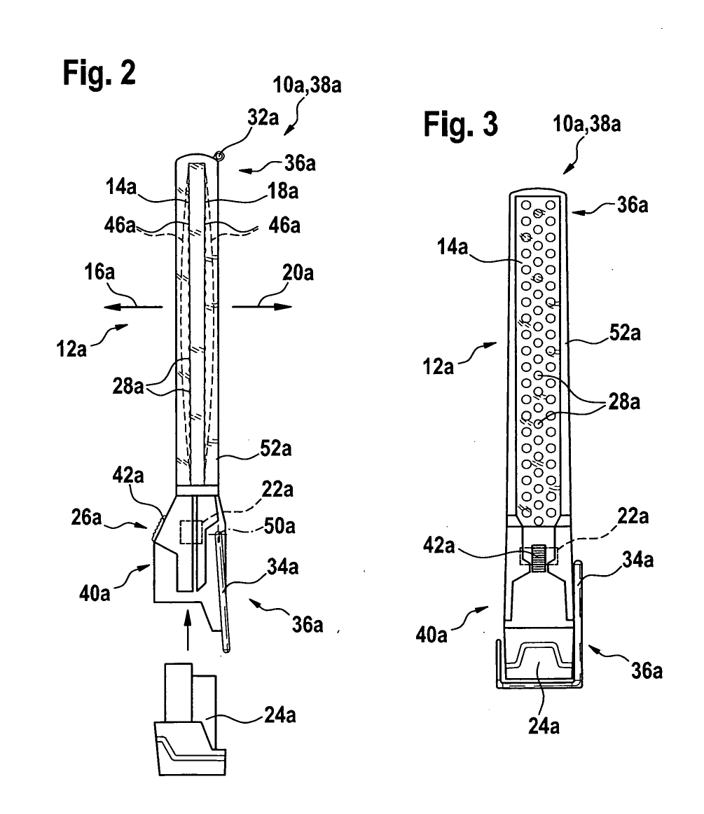

When flexible printed circuit board 46a is not bent, surface lighting means 14a have a narrow radiation angle, in particular on a plane perpendicular to a main extension of handheld lighting unit 10a, for example an angle of 90 degrees. When flexible printed circuit board 46a is bent, surface lighting means 14a have a wide radiation angle of, for example, approximately 180 degrees. Bent flexible printed circuit board 46a is illustrated by the dashed line in FIG. 2. Other radiation angles which appear practical to those skilled in the art are possible.

Surface lighting means 14a each have multiple illuminants 28a, which are designed as light-emitting diodes. Illuminants 28a emit a white light during operation. Illuminants 28a are distributed over a wide area, in multiple columns and multiple rows.

Fastening means 32a, 34a are situated in two end areas 36a of handheld lighting unit 10a. First fastening means 32a is situated on an end of light-emitting device 12a facing away from handle area 40a. It is designed as an eye. Handheld lighting unit 10a has a tie strap 48a. Tie strap 48a may be fastened to fastening means 32a.

Second fastening means 34a is designed as a supporting means. In an operating state, it extends from a connecting area between light-emitting device 12a and handle area 40a along handle area 40a away from light-emitting device 12a. The second fastening means is mounted pivotably around an axis 50a. Axis 50a is oriented perpendicularly to the main extension. Second fastening means 34a is locked in multiple positions during a pivot action.

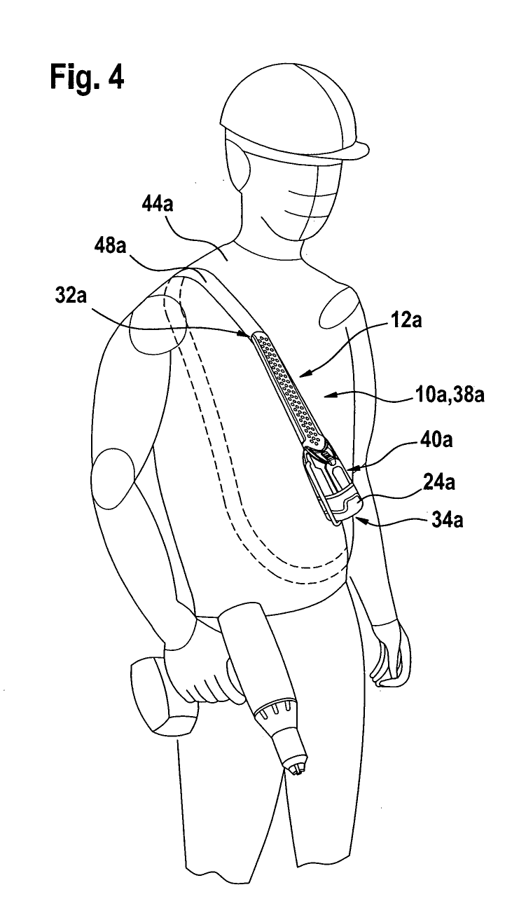

Tie strap 48a has a tab which may be fastened to second fastening means 34a. In the fastened state, light-emitting device 12a, second fastening means 34a and tie strap 48a form a loop which may be used to carry or attach handheld lighting unit 10a as illustrated in FIG. 4. An illuminant cover 52a of light-emitting device 12a is also designed to be flexible. Light-emitting device 12a may thus be adapted to the physical shape of operator 44a together with flexible surface lighting means 14a, 18a.

Handheld lighting unit 10a has a non-round outer contour 30a along the entire main extension, namely on planes which are oriented perpendicularly to a main extension.

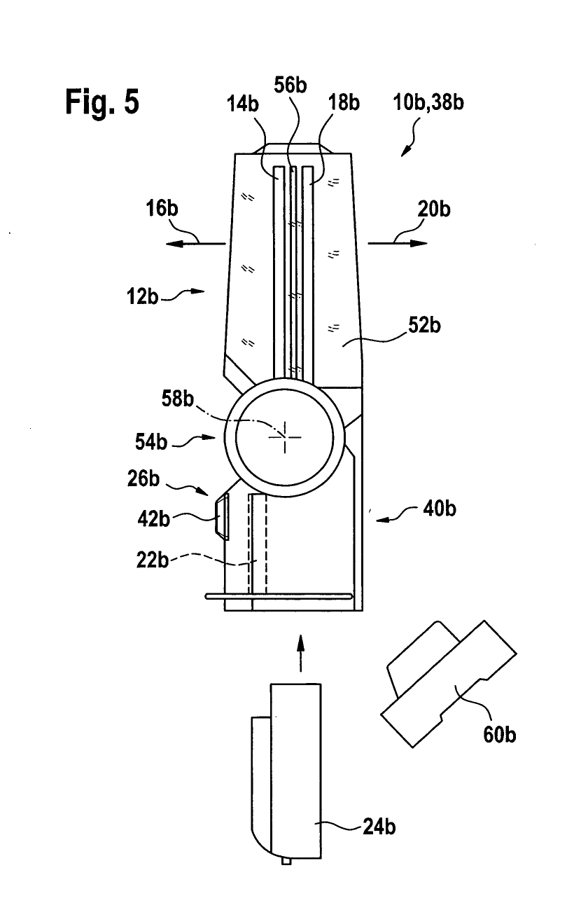

FIG. 5 shows a further exemplary embodiment of the present invention. The following descriptions and the drawings are largely limited to the differences between the exemplary embodiments, it being possible, in principle, to refer to the drawings and/or the description of the other exemplary embodiment with regard to identically identified components, in particular with regard to components having the same reference numerals. To distinguish between the exemplary embodiments, the letter a is added to the reference numerals of the exemplary embodiment in FIGS. 1 through 4. In the exemplary embodiment in FIG. 5, the letter a is replaced with the letter b.

FIG. 5 shows a system 38b having a handheld lighting unit 10b and a handheld power tool battery 24b. Handheld lighting unit 10b includes a light-emitting device 12b, a coupling means 22b, a handle area 40b and a pivoting device 54b. Light-emitting device 12b has a first surface lighting means 14b. First surface lighting means 14b emits a light flux in a first lighting direction 16b. Light-emitting device 12b also has a second surface lighting means 18b. Second surface lighting means 18b emits a light flux in a second lighting direction 20b which is different from first lighting direction 16b. Handheld lighting unit 10b has a switching unit 26b with the aid of which surface lighting means 14b, 18b are switchable independently of each other by an operator.

Light-emitting device 12b has a reflector 56b. Reflector 56b is situated between the two surface lighting means 14b, 18b. Reflector 56b reflects the light in such a way that both surface lighting means 14b, 18b have a radiation angle of approximately 180 degrees. Surface lighting means 14b, 18b are designed as low-pressure gas discharge lamps, specifically as fluorescent tubes. Light-emitting device 12b has an illuminant cover 52b which protects the surface lighting means 14b.

Pivoting device 54b is situated between light-emitting device 12b and handle area 40b. Pivoting device 54b positions light-emitting device 12b relative to handle area 40b pivotably around an axis 58b. Axis 58b is oriented perpendicularly to a main extension of handheld lighting unit 10b.

Coupling means 22b is situated within handle area 40b. In an operational state, handheld power tool battery 24b is situated in a battery receiving compartment of handheld lighting unit 10b within handle area 40b. Handheld lighting unit 10b has a battery cover 60b which covers the battery receiving compartment in the operational state.

What is claimed is:

1. A handheld lighting unit, comprising:
a light-emitting device having at least one first surface lighting arrangement and a second surface lighting arrangement, wherein the first surface lighting arrangement emits a light flux in a first lighting direction and the second surface lighting arrangement emits a light flux in a second lighting direction different from the first lighting direction.

2. The handheld lighting unit as recited in claim 1, further comprising:
a coupling arrangement configured to establish an operative connection to a handheld power tool battery.

3. The handheld lighting unit as recited in claim 1, wherein the light-emitting device has a switching unit configured to separately control the first surface lighting arrangement and the second surface lighting arrangement.

4. The handheld lighting unit as recited in claim 3, wherein the first and second surface lighting arrangements are situated at an angle of at least 90 degrees between the first lighting direction and the second lighting direction.

5. The handheld lighting unit as recited in claim 4, wherein at least one of the first and second surface lighting arrangements is configured to be deformable.

6. The handheld lighting unit as recited in claim 5, wherein at least one of the first and second surface lighting arrangements has multiple illuminants distributed over an area.

7. The handheld lighting unit as recited in claim 5, wherein at least one of the first and second surface lighting arrangements has at least one illuminant configured as a light-emitting diode.

8. The handheld lighting unit as recited in claim 5, wherein the handheld lighting unit has a non-round outer contour on at least one plane oriented perpendicularly to a main extension of the handheld lighting unit.

9. The handheld lighting unit as recited in claim 5, further comprising:
a fastening arrangement having at least two components, wherein the two components are at least partially situated in two end areas of the handheld lighting unit.
